(19) United States
(12) Patent Application Publication
(10) Pub. No.: US 2004/0084554 A1
(43) Pub. Date: May 6, 2004

(54) Fluid dispenser

(75) Inventor: Alex Milian, Breteuil Sur Iton (FR)

Correspondence Address: SUGHRUE MION, PLLC, 2100 PENNSYLVANIA AVENUE, N.W., SUITE 800, WASHINGTON, DC, 20037, US

(73) Assignee: VALOIS SAS

(21) Appl. No.: 10/690,610

(22) Filed: Oct. 23, 2003

Related U.S. Application Data
(60) Provisional application No. 60/432,666, filed on Dec. 12, 2002.

(30) Foreign Application Priority Data
Oct. 24, 2002 (FR) FR-02/13316

(51) Int. Cl. B05B 9/00

(52) U.S. Cl. 239/326

(57) ABSTRACT

A fluid dispenser characterized in that it comprises:

a gas reservoir (12) defining an actuating wall (120) for causing the volume of the reservoir to vary, and thereby driving the gas out of said reservoir;

at least one fluid reservoir (13) defining an actuating wall (130) for causing the volume of the reservoir to vary and thereby driving the fluid out of said reservoir;

at least one outlet orifice (141) common to the gas reservoir (12) and to a fluid reservoir (13);

a gas feed duct (15) which connects the gas reservoir (12) to the common outlet orifice (141); and

at least one fluid feed channel (16) which connects a fluid reservoir (13) to the common outlet orifice (141).

### CROSS REFERENCE TO RELATED APPLICATION

This application claims the benefit under 35 U.S.C. §119(e) of pending U.S. provisional patent application Serial No. 60/432,666, filed Dec. 12, 2002, and priority under 35 U.S.C. §119(a)-(d) of French patent application No. FR-02.13316, filed Oct. 24, 2002.

### BACKGROUND OF THE INVENTION

The present invention relates to a fluid dispenser for dispensing fluid in liquid or powder form, the dispenser comprising a reservoir defining an actuating wall that can be moved or deformed to cause the volume of the reservoir to vary and thereby to drive its contents out of the reservoir. This type of dispenser is further provided with an outlet or dispensing orifice that is connected to the reservoir so that, by actuating the reservoir, a portion of its contents is dispensed through the outlet orifice.

In general, the reservoir contains the fluid in liquid or powder form, but it can also contain gas, e.g. air. In which case, by actuating the wall of the reservoir, a mixture of air and of the fluid is driven through the outlet orifice. This type of dispenser is applicable to the fields of perfumes, cosmetics, or indeed pharmaceuticals.

Document FR 2 791 645 discloses a dispenser of this type made up of two deformable flexible sheets that are sealed together around their peripheries so as to form an internal volume defining a fluid reservoir. A dispensing piece is advantageously fixed by sealing between the two sheets. That piece advantageously defines a dispensing orifice and also serves as a support piece for an element made of a porous material suitable for being soaked or impregnated with fluid in liquid or powder form. In addition, the reservoir contains a spring making it possible to return the two sheets into a rest configuration defining the maximum volume of the reservoir. The spring makes it possible to return the reservoir to its rest position each time the dispenser is actuated. The reservoir contains a small quantity of fluid and a larger quantity of gas, e.g. air. Thus, each time the dispenser is actuated, a mixture of air and of fluid is delivered through the dispensing orifice. In that document, provision is also made to close off the dispensing orifice by means of a removable closure member while the reservoir contains almost only fluid, and the spring is compressed to a state close to its maximum. Thus, so long as the removable member is in place, the reservoir is maintained at a minimum volume, and the fluid that it contains hardly makes any contact with air. It is only when the removable closure member is removed that the spring can relax so that the volume of the reservoir increases by means of air entering through the dispensing orifice. Then, the dispenser is actuated by pressing the flexible sheets that constitute the deformable actuating walls. Once the pressure on the sheets is released, the spring contained in the reservoir returns it to its initial maximum volume state.

The drawback with that prior art dispenser lies in the fact that fluid can leak out through the dispensing orifice so long as there is fluid in the reservoir or in the piece of porous material. And it is not possible to remedy that drawback by closing the dispensing orifice because the removable closure member is not re-positionable. Therefore, it is almost impossible to keep that dispenser once it has been used, even if it still contains fluid, because of the risk of leakage.

### SUMMARY OF THE INVENTION

An object of the present invention is to remedy that prior art drawback by defining a fluid dispenser in which there is no risk of it leaking even in the absence of a stopper or of a closure member for closing the dispensing orifice.

The invention achieves this object by providing a fluid dispenser comprising: a gas reservoir defining an actuating wall for causing the volume of the reservoir to vary, and thereby driving the gas out of said reservoir; at least one fluid reservoir defining an actuating wall for causing the volume of the reservoir to vary and thereby driving the fluid out of said reservoir; at least one outlet orifice common to the gas reservoir and to a fluid reservoir; a gas feed duct which connects the gas reservoir to the common outlet orifice; and at least one fluid feed channel which connects a fluid reservoir to the common outlet orifice. By separating the gas reservoir from the fluid reservoir(s) in this way, it is possible to control with more precision the quantity of fluid fed to the common outlet orifice. This can be seen even more clearly when the dispenser has a plurality of fluid reservoirs, so that it is, for example, possible to dimension the fluid reservoir so that it is emptied by actuating the wall of the gas reservoir only once or twice. Thus, it is guaranteed that no fluid remains at the common outlet orifice after the gas reservoir has been actuated once or twice. In addition, it should be noted that the gas reservoir never contains any fluid. Advantageously, the duct meets the channel at the outlet orifice. Thus, it is almost impossible for fluid to penetrate into the gas reservoir through the feed duct.

According to another characteristic of the invention, the outlet orifice is formed at an outlet chamber into which the duct and the channel open out. Advantageously, the chamber contains a piece of porous material suitable for being impregnated with fluid. Preferably, the piece of porous material is disposed between the duct and the channel. Thus, the piece of porous material acts as a plug between the duct and the channels by preventing the fluid from propagating along the feed duct for feeding the gas reservoir. It can even be said that the piece of porous material acts as a porous stopper. The fluid and the gas are thus completely separated from each other, almost as far as the outlet orifice, and more generally as far as the outlet chamber.

According to another advantageous characteristic of the invention which contributes to preventing any leakage of fluid at the outlet orifice, the channel is provided with initial closing-off means suitable for interrupting the communication between the fluid reservoir and the outlet orifice via the channel. Advantageously, the initial closing-off means are suitable for being opened by actuating the actuating wall of the fluid reservoir. Thus, it is possible to omit a removable closure member placed at the outlet orifice for closing it off in airtight manner before the dispenser is used for the first time or between occasions on which it is used. Each fluid reservoir is isolated from the outlet orifice before it is used. As soon as the actuating wall is pressed, the initial closure means are broken and the fluid contained in the reservoir can flow out to the outlet orifice via the resulting cleared channel. It is then necessary merely to actuate the wall of the gas reservoir in order to dispense a mixture of fluid and of gas. After said wall has been actuated a few times, there is no longer any fluid either in the reservoir or at the outlet orifice. There is thus no risk of the dispenser leaking. The next time the dispenser is used, it is necessary merely to actuate the second fluid reservoir in order to break its initial closure means, in the same way as with the first reservoir, and so on for the other fluid reservoirs. Thus, a fluid dispenser is obtained in which there is no risk of it leaking at any time provided that the actuating wall of the gas reservoir has been actuated enough times to empty the fluid reservoir used and its feed channel. When a piece of porous material is disposed at the outlet orifice, the fluid reservoir and its associated feed channel are emptied almost automatically by capillary action due to the structure of the piece of porous material. Thus, it is guaranteed that the reservoir and its channel are empty after the actuating wall of the fluid reservoir in question has been actuated.

According to another advantageous characteristic of the invention, the reservoirs, the duct, and said at least one channel are formed between two sheets fixed together locally. Advantageously, one sheet is substantially deformable and forms the actuating walls of the reservoirs. Preferably, the sheet is a shaped-section shell that is advantageously thermoformed. In addition, the other sheet is substantially plane. This is a particularly inexpensive embodiment, given that the dispenser may be made up of two elements only, namely the two sheets. When the piece of porous material is incorporated, the number of component pieces of the dispenser is increased to three. For example, such a dispenser can be used as a free sample which can even be included in publications, e.g. in magazines, in view of its particularly flat configuration.

In another embodiment more particularly adapted to medical or cosmetological uses, the dispenser has at least two fluid reservoirs containing different fluids to be mixed advantageously extemporaneously at the outlet orifice.

### BRIEF SUMMARY OF THE DRAWINGS

The invention is described more fully below with reference to the accompanying drawings which show an embodiment of the invention by way of non-limiting example.

In the figures:

FIG. 1 is a perspective view from above and from the side of a fluid dispenser in a first embodiment of the invention;

FIG. 2 is a view in longitudinal vertical section through the dispenser of FIG. 1; and

FIG. 3 is a perspective view from above of a dispenser in a second embodiment of the invention.

### DETAILED DESCRIPTION OF THE INVENTION

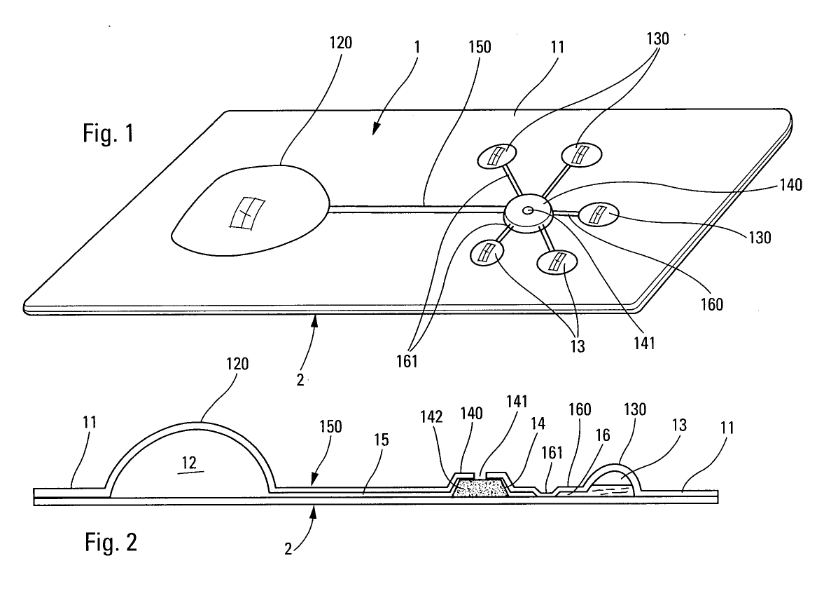

The embodiment used to illustrate the present invention and shown in FIGS. 1 and 2 is merely a preferred embodiment more specially adapted to being used as an inexpensive dispenser of the sample type. However, it may also be used as a fully-fledged saleable dispenser rather than being distributed as a sample.

In this particular embodiment, the dispenser is made up of three component parts, namely a top sheet 1, a bottom sheet 2, and a piece of porous material 142. The piece of porous material 142 is optional, and, in certain cases, it may be omitted, so that the dispenser is then made up of two component elements only, namely the two sheets 1 and 2.

The term “sheet” used herein should be understood in the broad sense as being any element having a wall thickness that is relatively small in one dimension, while, in the other dimensions, the element may extend over a large area. In addition, the element may have a small wall thickness that is constant or that varies. Furthermore, the element may be very flexible, relatively flexible, relatively rigid, or very rigid. It may also be flexible or deformable locally or entirely. Said element may be fully plane, or else it may have one or more projecting pieces in relief. Thus, one sheet or both sheets may be in the form of a flexible or rigid plate advantageously having one or more pieces in relief. Herein, the term “sheet” covers the following terms: plate, substrate, backing, film, shell, etc.

In the embodiment shown in FIGS. 1 and 2, the sheet 1 is in the form of a shaped-section shell that is advantageously thermoformed, and that has a plane main zone 11 which extends over the entire periphery of the sheet. The sheet 1 forms a main dome 120 which projects relative to the plane zone 11, as can be seen clearly in FIG. 2. The sheet or shell 1 also forms a rib in relief 150 which extends from the dome 120 to a promontory in relief 140 provided with an outlet orifice 141. The rib in relief 150 thus connects the main dome 120 to the promontory 140. A plurality of secondary ribs 160 further extend from the promontory 140 in a star configuration. In this example, there are five such secondary ribs 160, but this number is not limiting. The secondary ribs 160 thus extend radially outwards from the promontory 140 and each of them connects to a respective secondary dome 130 which may, for example, be a scaled-down model of the main dome 120.

The main rib 150, the promontory 140, and the secondary ribs 160 may be either flexible or non-deformable. The main dome 120 and the secondary domes 130 are formed to be deformable and advantageously elastically deformable so that, after being deformed, they can return to their initial convex shape as shown in FIG. 2. Naturally, the curvature of the domes 120 and 130 may be marked to various extents, i.e. convex or flattened, and may be of any geometrical shape, e.g. polygonal or ellipsoidal.

The bottom second sheet 2 may be in the form of a plane rigid substrate or of a flexible sealing film, or else in the form of a plane or shaped-section shell. It can even be imagined that the bottom sheet 2 may be identical to the top sheet 1, i.e. in the form of a shaped-section shell.

The top sheet 1 is connected to the bottom sheet 2 at the plane zone 11 which comes into contact with the bottom sheet 2. The sheets 1 and 2 may be sealed together around their peripheries, and preferably around the domes 120 and 130 and along the ribs 150 and 160, as well as around the promontory 140. Thus, a space is formed between the two sheets under the domes, the ribs, and the promontory. In the invention, the dome 120 defines a gas reservoir 12, the main rib 150 defines a feed duct 15, the secondary domes 130 define respective fluid reservoirs 13, the secondary ribs 160 define respective fluid feed channels 16, and the promontory 140 defines a common outlet chamber 14. This can be seen in FIG. 2. Thus, the outlet chamber 14 at which the outlet or dispensing orifice 141 is defined communicates with the gas reservoir 12 via the feed duct 15. In addition, the same common outlet chamber 14 communicates with the fluid reservoirs 13 via the fluid feed channels 16. It can thus be observed that the gas feed duct 15 meets the fluid feed channels 16 at the common outlet channel 14 only. Since the chamber 14 can be small so as to define only the zone situated under the outlet orifice 141, it can be said that the duct 15 meets the channels 16 at the dispensing orifice 141 only.

Advantageously, the common outlet chamber 14 may contain a piece of porous material 142 suitable for being impregnated with fluid in liquid or powder form. The piece of porous material 142 is situated in the immediate vicinity of and even in contact with the dispensing orifice 141. It can also be observed that the duct 15 can communicate with a channel 160 only via said piece of porous material 142. Thus, it acts as a plug or a porous stopper that prevents any fluid from flowing back up the channel 15 which is connected to the gas reservoir 12. Thus, the fluid and the gas are completely separated from each other in the dispenser: they meet only at the dispensing orifice 141 which may advantageously be provided with the piece of porous material 142.

In another aspect of the invention, at least one of the channels, and preferably all of the channels, is/are closed or stopped up at one or more places along its/their length(s), so that the fluid reservoirs 13 are initially isolated from the outlet chamber 14, and therefore from the dispensing orifice 141. This occlusion of the channels 160 may, for example, be implemented in the form of weak seals 161 between the sheets 1 and 2 at the channels 16, as can be seen in FIG. 2. The function of each weak seal 161 is to come apart or to break when the pressure in the corresponding channel 16 is sufficient to detach the sheet 1 from the sheet 2, and thus to reconstitute the channel 16 over its entire length. The pressure necessary may, for example, be generated by pressing the actuating wall formed by the secondary dome 130. Naturally, it is possible to imagine initial closing-off means other than such weak seals 161. However, such seals constitute a simple embodiment since they implement a sealing technique that is already advantageously used to connect the two sheets 1 and 2 together. Naturally, the weak seal 161 may be situated closer to the chamber 14 or closer to the chamber 13. Thus, each fluid reservoir is isolated from the chamber 14 prior to use. There is thus no risk of any leakage occurring at the outlet orifice 141, even in the absence of a removable closure member serving to close off the dispensing orifice in leaktight manner. When the dispenser is used for the first time, the user presses one of the secondary domes 130, thereby causing the weak seal 161 to break and the contents of the reservoir 13 to be delivered into the common outlet chamber 14 in which the piece of porous material 142 is advantageously situated. It should be noted that the other reservoirs are still isolated from the chamber 14. The user then presses the actuating wall of the gas reservoir 12 constituted by the main dome 120. This causes the gas contained in the reservoir 12 to be delivered via the duct 15 to the chamber 14 containing the piece of porous material 142 soaked or impregnated with the fluid from the chamber 13. The gas under pressure that reaches the chamber 14 passes through the piece of porous material 142 and exits via the outlet orifice 141 while entraining with it the fluid with which the piece of porous material 142 is impregnated. At the outlet of the orifice 141, a two-phase jet of fluid and of gas is thus obtained. After dispensing, the user releases the pressure on the main dome 120 which, due to its elastic deformation memory, returns to its rest position as shown in FIG. 2. By determining with precision the quantity of fluid contained in the reservoir 13, it is also possible to determine with precision the number of times it is necessary to actuate the main dome 120 in order to empty the piece of porous material 142 of all or almost all of the fluid from the chamber 13. Thus, for example, after the main dome 120 has been actuated once or twice, there is no fluid or almost no fluid remaining impregnated or soaked inside the piece of porous material 142. There is therefore no risk of any leakage through the outlet orifice 141. If the user wishes to dispense more fluid, the user presses a second secondary dome 130 to deliver, once again, a metered quantity or “dose” of fluid into the piece of porous material 142, and so on. The main dome has a shape memory biasing it toward its initial position. This is not necessary for the secondary domes.

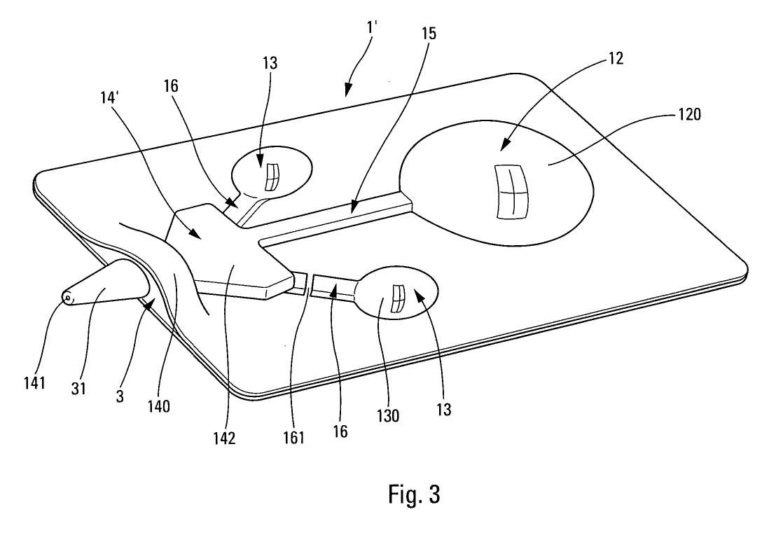

FIG. 3 shows a second embodiment of a dispenser of the invention. This dispenser 1′ may also be made up of two sheets or plates sealed together locally. Thus, the dispenser 1′ forms a gas reservoir 12 defining an actuating dome 120, and two fluid reservoirs 13 also provided with respective actuating domes 130. The reservoirs 12 and 13 are connected to a mixing chamber 14′ in which a piece of porous material 142 is advantageously situated. The gas reservoir 12 communicates with the mixing chamber 14′ via a duct 15, while the fluid reservoirs 13 communicate with the same chamber 14′ via channels 16. Advantageously, the channels 16 are provided with interrupting means 161 which may also be in the form of weak seals 161, as in the preceding embodiment.

In this embodiment, each of the two fluid chambers 13 contains a different type of fluid serving to be mixed extemporaneously in the mixing chamber 14′.

This embodiment also differs from the preceding embodiment in that the dispenser 1′ further comprises a dispensing and support piece 3 which may, for example, be made of an injection-molded plastics material. This support piece 3 may define a support recess for the piece of porous material 142 and a fixing appendage situated at the promontory 140. The sheets or plates making up the dispenser 1′ may, for example, be sealed to the support piece 3. In addition, the support piece 3 defines an end-piece 31 at the free end of which the dispensing orifice 141 is defined. The end-piece 31 may be a nasal applicator.

This dispenser 1′ is used as follows:

The user starts by pressing a dome 130 of one of the fluid reservoirs 13 so as to break the weak seal 131 so that the fluid contained under the dome can flow out through the resulting reconstituted channel so as to reach the mixing chamber in which the piece of porous material 142 is advantageously situated. The user then proceeds symmetrically for the other fluid reservoir. Thus, the two different types of fluid can be mixed in the mixing chamber inside the piece of porous material. It is then necessary merely for the user to press the actuating dome 120 of the gas reservoir 12 to drive the gas through the duct 15 into the piece of porous material 142. The effect of this is to entrain the mixture of fluid impregnated in the piece of porous material through the end-piece 31 so as finally to be dispensed in the form of a two-phase spray at the outlet orifice 141.

The dispenser 1′ of FIG. 3 is more particularly adapted to medical or cosmetological use.

By means of the invention, an advantageously multi-dose two-phase dispenser is obtained in which the separation between the fluid and the gas is total, and which has no leakage defects. In addition, it can be implemented in an inexpensive version that can be used as a sample.

The provision of a plurality of fluid reservoirs together with a sole gas reservoir may be protected independently, i.e. without the provision of the gas duct connecting the fluid channel only at the level of common outlet orifice.

1/ A fluid dispenser characterized in that it comprises:
a gas reservoir (12) defining an actuating wall (120) for causing the volume of the reservoir to vary, and thereby driving the gas out of said reservoir;
at least one fluid reservoir (13) defining an actuating wall (130) for causing the volume of the reservoir to vary and thereby driving the fluid out of said reservoir;
at least one outlet orifice (141) common to the gas reservoir (12) and to a fluid reservoir (13);
a gas feed duct (15) which connects the gas reservoir (12) to the common outlet orifice (141); and
at least one fluid feed channel (16) which connects a fluid reservoir (13) to the common outlet orifice (141).

2/ A dispenser according to claim 1, in which the duct (15) meets the channel (16) at the outlet orifice (141).

3/ A dispenser according to claim 1, in which the outlet orifice (141) is formed at an outlet chamber (14) into which the duct (15) and the channel (16) open out.

4/ A dispenser according to claim 3, in which the chamber (14) contains a piece of porous material (142) suitable for being impregnated with fluid.

5/ A dispenser according to claim 4, in which the piece of porous material (142) is disposed between the duct (15) and the channel (16).

6/ A dispenser according to claim 1, in which the channel (16) is provided with initial closing-off means (161) suitable for interrupting the communication between the fluid reservoir (13) and the outlet orifice (141) via the channel (16).

7/ A dispenser according to claim 6, in which the initial closing-off means (161) are suitable for being opened by actuating the actuating wall (130) of the fluid reservoir (13).

8/ A dispenser according to claim 1, in which the reservoirs (12, 13), the duct (15) and said at least one channel (16) are formed between two sheets (1, 2) fixed together locally.

9/ A dispenser according to claim 8, in which one sheet (1) is substantially deformable and forms the actuating walls (120, 130) of the reservoirs (12, 13).

10/ A dispenser according to claim 9, in which the sheet (1) is a shaped-section shell that is advantageously thermoformed.

11/ A dispenser according to claim 9, in which the other sheet (2) is substantially plane.

12/ A dispenser according to claim 1, having a plurality of fluid reservoirs connected through respective feed channels to the common outlet orifice.

13/ A dispenser according to claim 1, having at least two fluid reservoirs (13) containing different fluids to be mixed advantageously extemporaneously at the outlet orifice.
